(19) United States
(12) Patent Application Publication
(10) Pub. No.: US 2026/0236496 A1
(43) Pub. Date: Aug. 13, 2026

(54) AUTOMATED DATA TO FUNCTION MAPPING USING AGENTIC PROMPT PROCESSING UNITS

(71) Applicant: Cisco Technology, Inc., San Jose, CA (US)

(72) Inventors: Marcelo Yannuzzi, Nuvilly (CH); Jean Andrei Diaconu, Gaillard (FR); Hervé Muyal, Gland (CH); Arash Salarian, Chardonne (CH)

(73) Assignee: Cisco Technology, Inc., San Jose, CA (US)

(21) Appl. No.: 19/262,613

(22) Filed: Jul. 8, 2025

Related U.S. Application Data
(60) Provisional application No. 63/757,450, filed on Feb. 12, 2025.

(51) Int. Cl. G06F 16/3329; G06F 40/30

(52) U.S. Cl. CPC G06F 16/3329; G06F 40/30

(57) ABSTRACT

In one implementation, a device obtains a natural language prompt for processing by a generative artificial intelligence model. The device identifies, prior to the generative artificial intelligence model processing the natural language prompt, a type of data that the generative artificial intelligence model would need to generate a response to the natural language prompt. The device identifies one or more data retrieval functions that are able to retrieve the type of data. The device provides an indication of the one or more data retrieval functions to the generative artificial intelligence model for use when processing the natural language prompt to generate the response.

### RELATED APPLICATION

This application claims priority to U.S. Prov. Appl. Ser. No. 63/757,450, filed Feb. 12, 2025, entitled AUTOMATED DATA TO FUNCTION MAPPING USING AGENTIC PROMPT PROCESSING UNITS, by Marcelo Yannuzzi, et al., the contents of which are incorporated herein by reference.

### TECHNICAL FIELD

The present disclosure relates generally to computer networks, and, more particularly, to automated data to function mapping using agentic prompt processing units (PPUs).

### BACKGROUND

The recent breakthroughs in large language models (LLMs) represent new opportunities across a wide spectrum of industries. More specifically, the ability of new models to follow instructions now allows for interactions with tools that can perform tasks such as searching the web, executing code, etc. In addition, agents can be developed to perform complex tasks and workflows by chaining multiple calls to one or more LLMs.

For instance, using one or more agents to accurately identify enterprise data being requested in a prompt is not trivial, especially, when the user and/or agent that generated the prompt do not even know where the data sits within the company. Furthermore, even if an agent could correctly identify the specific set of data sources required, it still does not understand how to resolve and map the identified data to appropriate retrieval functions. In common enterprise scenarios with hundreds of potential data sources, there can be tens of thousands of possible functions to choose from.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example of an architecture for sending prompts to a remote language model;

FIG. 4 illustrates an example of an architecture utilizing prompt processing units;

FIG. 5 illustrates an example of an environment within which enterprise data may be utilized as part of complex workflows;

FIG. 6 illustrates an example of an architecture for retrieving data stored in enterprise data sources incorporating a system for automated and manageable data to function mapping using agentic prompt processing units;

FIG. 7 illustrates an example of a plan confirmation procedure;

FIG. 8 illustrates an example of a component of the system for automated and manageable data to function mapping using agentic prompt processing units;

FIG. 9 illustrates an example of a system for feeding and populating a data catalog;

FIG. 10 illustrates an example of a configuration procedure for populating a functions catalog, a data catalog as well as a function matrix; and

FIG. 11 illustrates an example simplified procedure for automated data to function mapping using agentic prompt processing units, in accordance with one or more implementations described herein.

### DESCRIPTION OF EXAMPLE IMPLEMENTATIONS

### Overview

According to one or more implementations of the disclosure, a device obtains a natural language prompt for processing by a generative artificial intelligence model. The device identifies, prior to the generative artificial intelligence model processing the natural language prompt, a type of data that the generative artificial intelligence model would need to generate a response to the natural language prompt. The device identifies one or more data retrieval functions that are able to retrieve the type of data. The device provides an indication of the one or more data retrieval functions to the generative artificial intelligence model for use when processing the natural language prompt to generate the response.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

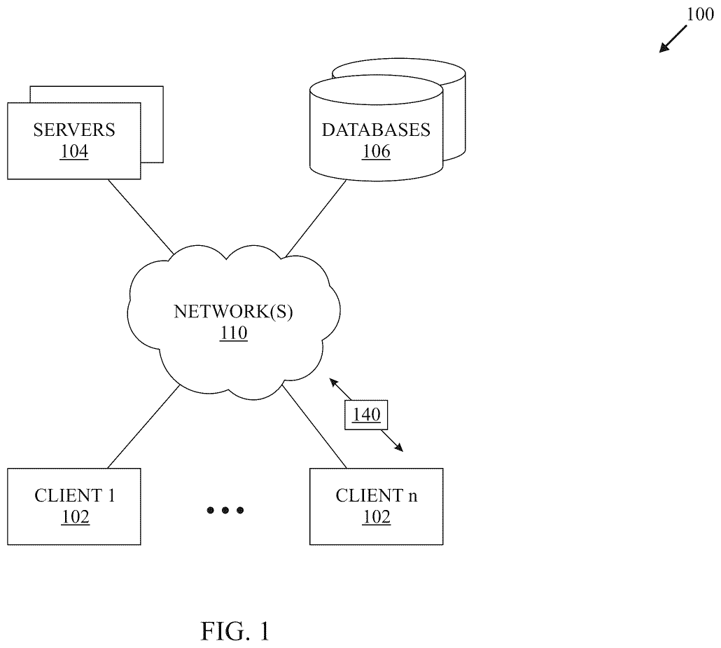

FIG. 1 is a schematic block diagram of an example simplified computing system (e.g., computing system 100) illustratively comprising any number of client devices (e.g., client devices 102 with, e.g., a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, servers 104 and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

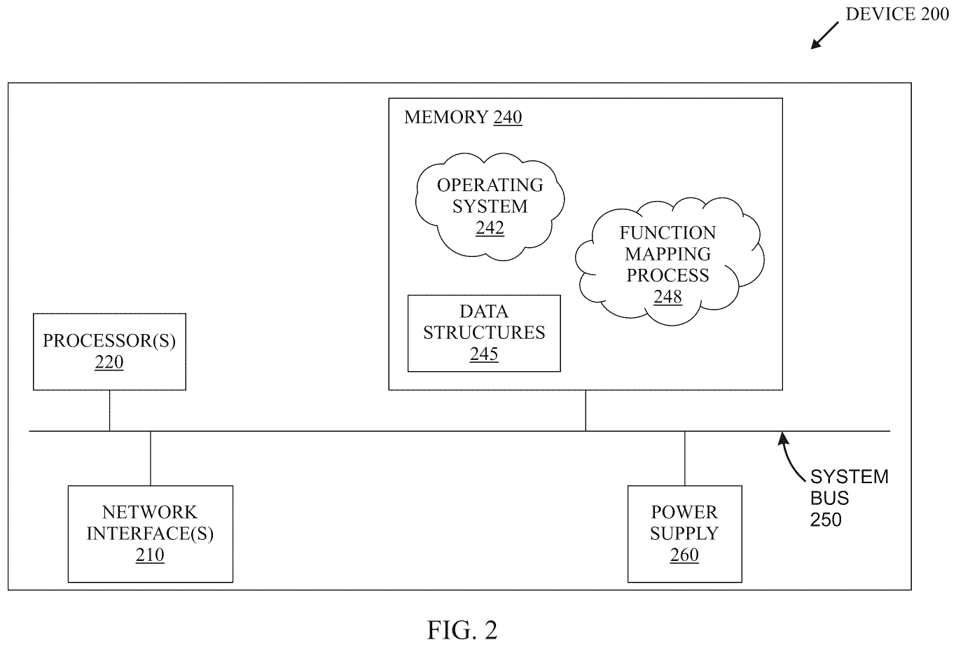

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processes and/or services executing on the device. These software processes and/or services may comprise one or more functional processes, and on certain devices, a function mapping process 248, as described herein. Notably, the functional processes, when executed by processor(s) 220, may cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, function mapping process 248 may include computer executable instructions that, when executed by processor(s) 220, cause device 200 to perform the techniques described herein. For example, function mapping process 248 may include computer-executable instructions stored on a computer-readable medium that are executable by processor(s) 220 to cause node/device 200 to leverage a data to function mapping technique using agentic prompt processing units to provide verifiable means to correctly identify the enterprise data required before an agentic plan is executed along with automated mappings between a breakdown of the enterprise data required and a set of functions capable of retrieving such data.

To do so, in some implementations, function mapping process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, function mapping process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that function mapping process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, function mapping process 248 may also include one or more generative artificial intelligence/machine learning models. In contrast to discriminative models that simply seek to perform pattern matching for purposes such as data access controls, anomaly detection, classification, or the like, generative approaches instead seek to generate new content or other data (e.g., audio, video/images, text, etc.), based on an existing body of training data. For instance, in the context of prompt analysis, function mapping process 248 may use a generative model to dynamically provide verifiable means to correctly identify the enterprise data required before an agentic plan is executed along with automated mappings between a breakdown of the enterprise data required and a set of functions capable of retrieving such data. Example generative approaches can include, but are not limited to, generative adversarial networks (GANs), foundation models such as large language models (LLMs), other transformer models, and the like.

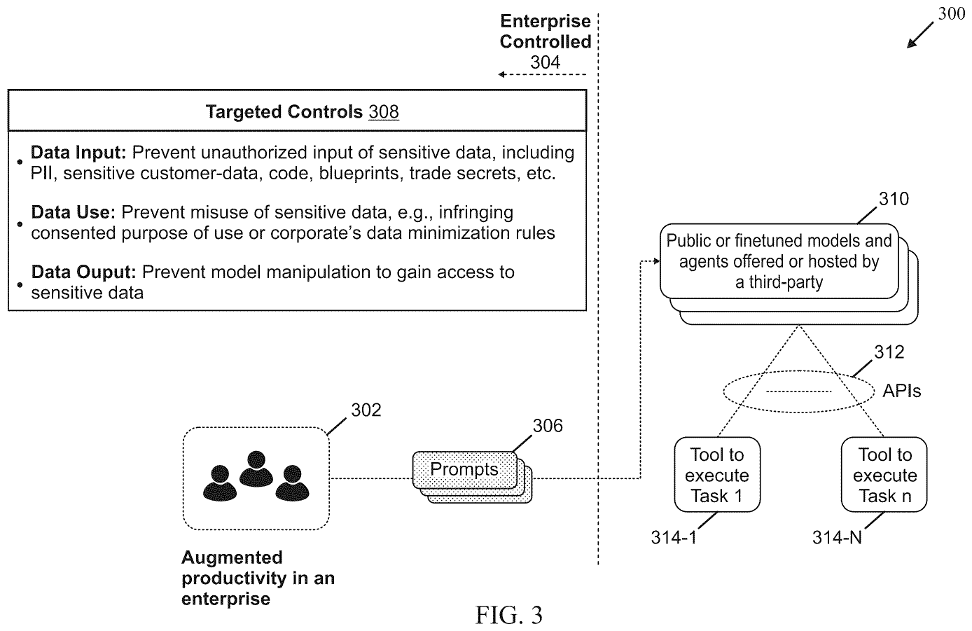

FIG. 3 illustrates an example of an architecture 300 for sending prompts to a remote language model, in accordance with one or more implementations described herein. In architecture 300, users 302 in an enterprise-controlled portion 304 (e.g., network) may send prompts 306 (e.g., queries, etc.) to an external machine learning model (e.g., machine learning model 310).

Typically, prompts 306 may be generated based on input directly from users 302, such as via a chatbot assistant. However, further implementations provide for the use of other programmatic approaches to generate prompts 306, such as by a user selecting a button within a user interface and the underlying program generating a prompt, or the like. In some instances, the executing program may send prompts 306 to machine learning model 310 via one or more application programming interfaces (APIs) and present the results to users 302, accordingly.

Machine learning model 310 may be a public or finetuned language model, such as an LLM, or any other generative AI model configured to process the prompts 306. For example, users 302 such as sales, marketing, customer support, data analytics, engineering, product management, or other personnel in the enterprise may utilize prompts 306 to enhance their productivity.

The increased use of generative AI is posing new challenges to enterprises with respect to data control. More specifically, enterprises need mechanisms that can prevent unauthorized input of sensitive data, the misuse of sensitive data, and/or model manipulation to gain access to sensitive data when utilizing generative AI. Indeed, sensitive data leakage and enterprise policy violations with generative AI are a key concern given that sensitive information may be referenced, used, and/or extracted indirectly (i.e., without explicitly being part of a query).

Further, sensitive information is often needed to complete a task, so personally identifiable information (PII) masking or redaction techniques may not work. In fact, in many cases, it is possible to use model-based analysis to detect the source even after masking or redacting PII. Furthermore, sensitive information may be misused (e.g., for a secondary purpose not compliant with consented purpose of use or by infringing Data Minimization Rules (DMRs)). For instance, specific enterprise controls are often not covered by masking filters and/or redaction techniques. It makes little sense to apply pattern matching controls, such as regular expressions (regex), Exact Data Matching (EDM), or Indexed Document Matching (IDM) techniques to next generation natural language-based systems.

Although many enterprises aim to leverage generative AI, they may also want to observe what tasks are requested by prompts 306 for performance by machine learning model 310. Additionally, users may want to observe and control what data is sent, used, and returned by these third-party systems. Consequently, while the prompts 306, users 302, and any corresponding API calls that they may make may be within the enterprise-controlled portion 304, companies may want to observe and control what data is sent, used, and returned by third-party systems, such as learning model 310.

During processing of any of prompts 306, machine learning model 310 may itself leverage one or more APIs 312 to interact with a set of tools 314 (e.g., a first tool 314-1 through nth tool 314-n) to perform any number of discrete tasks. For instance, the set of tools 314 may allow machine learning model 310 to retrieve information from a certain source, as part of its processing. More complex approaches also provide for the set of tools 314 allowing machine learning model 310 to exert some control over an underlying system or device.

Also as shown, from the perspective of the enterprise, there may be a set of targeted controls 308 that the enterprise desires, such as any or all of the following:
Data input—e.g., preventing the unauthorized input of sensitive data, including PII, customer data, code, blueprints, trade secrets, etc.
Data use—e.g., prevent misuse of sensitive data, such as infringing a consented purpose of use or the data minimization rules of the entity
Data output—e.g., preventing manipulation of machine learning model 310 to gain access to the sensitive data

While many online machine learning models (e.g., ChatGPT, etc.) today are able to interpret open-ended prompts and act upon them by generating artifacts based on such understanding, this skill is also not accessible to the enterprise itself. This lack of skill hinders the ability to effectively implement all of the additional controls (e.g., set of targeted controls 308) listed above on the data, before prompts 306 are sent to an external entity from that of the enterprise.

### Data Controls Using Prompt Processing Units

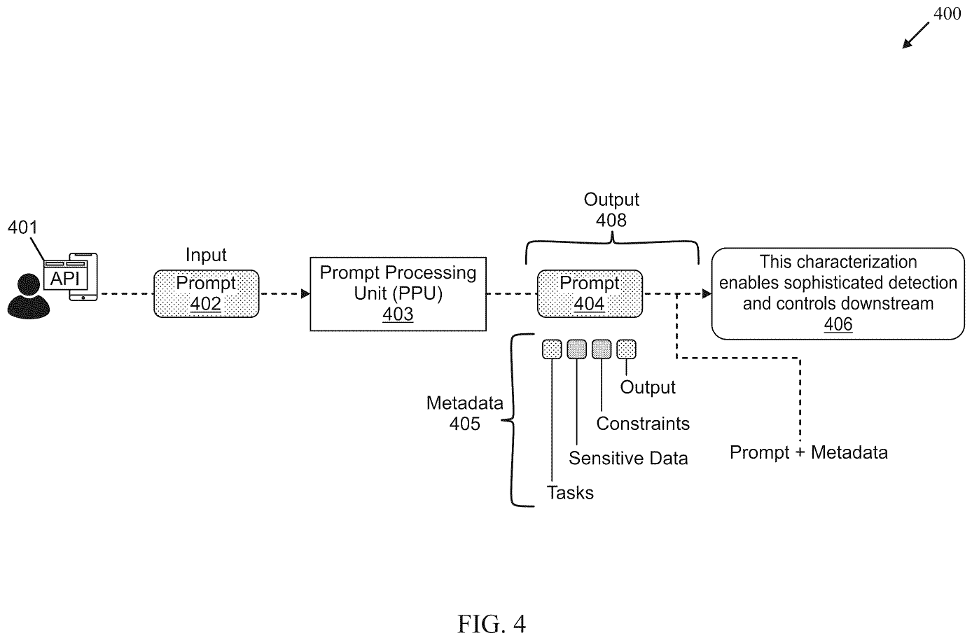

FIG. 4 illustrates an example of an architecture 400 for utilizing PPUs, according to various implementations. In some instances, architecture 400 may be a portion of a data control system that leverages the outputs of PPUs to institute downstream data controls.

As shown, architecture 400 includes a prompt processing unit (PPU 403). A PPU 403 may be a highly efficient processing element that may receive a prompt 402 as an input (e.g., from a user chat interface or an API 401). PPU 403 may parse the query and/or may detect a set of key features from the query carried in a prompt at inference time.

For instance, PPU 403 may detect key features within the prompt 402. These may include the class of tasks requested to an LLM (e.g., “Coding Support”), additional details about the class of tasks detected (e.g., “create a python program”), the data needed to complete the tasks (e.g., a snippet of python code), any constraints applicable to carry out the tasks (e.g., “use the code snippet provided”, or “stick to NumPy”), the desired output upon completion of such tasks (e.g., “stdout”), etc.

A PPU 403 may act as a transparent element, delivering the unmodified prompt 404 augmented with metadata 405 carrying the key features, such as those described above. More specifically, a PPU 403 may systematically distill and characterize prompts, allowing for downstream controls 406 to be applied.

### Automated Data to Function Mapping

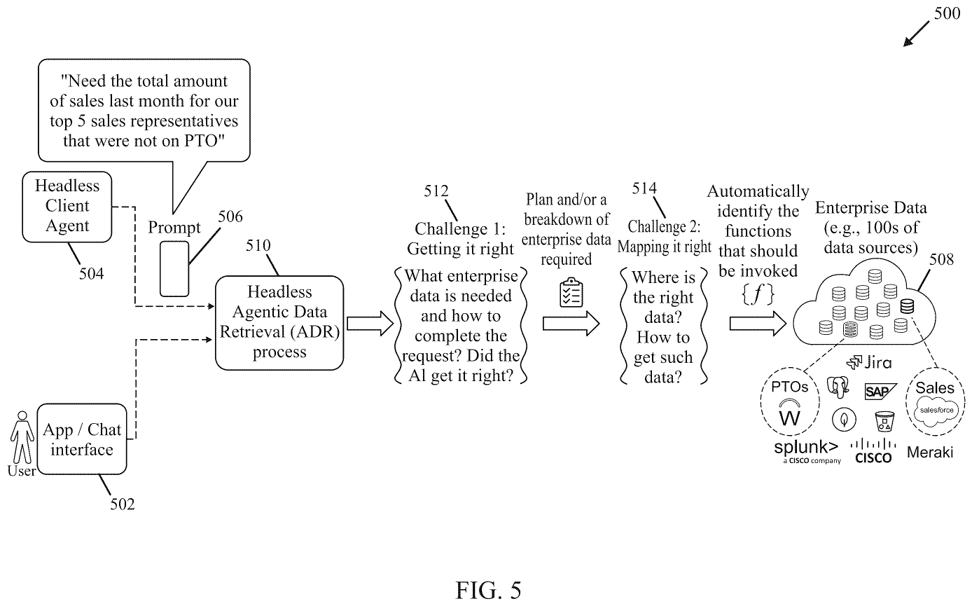

FIG. 5 illustrates an example of an environment 500 within which enterprise data may be utilized as part of complex workflows, in accordance with one or more implementations described herein. Environment 500 may be an environment where an agentic prompt processing unit (PPU) may be deployed to provide verifiable means to correctly identify the enterprise data required before an agentic plan is executed along with automated mappings between a breakdown of the enterprise data required and a set of functions capable of retrieving such data.

As noted above, the ability of conventional LLMs to follow instructions now allows for interactions with tools that can perform tasks such as searching the web, executing code, etc. In addition, agents can be developed to perform complex tasks and workflows by chaining multiple calls to one or more LLMs.

However, leveraging generative artificial intelligence (GenAI) using agents is not without challenges. For instance, a human user (e.g., user 502) or a headless client agent (e.g., agent 504) may generate a prompt 506, where the completion of such prompt by one or more LLMs requires the use of data stored in one or more enterprise data sources 508 (e.g., Workday, Salesforce, etc.). Another headless agent, such as an Agentic Data Retrieval (ADR) process (e.g., ADR process 510) may receive the prompt 506, either by working in tandem with the one or more LLMs or by being placed on the path toward the one or more LLMs.

A first challenge 512 for an ADR process 510 may lie in accurately identifying the enterprise data being requested by the prompt 506, especially, when the user 502 and/or agent 504 that generated the prompt do not even know where the data sits within the company.

In many cases, prompts won't carry any explicit reference to the data sources required to complete the request, so it's up to the ADR process 510 to make that determination. Complicating matters, a company may have hundreds of possible sources from which to draw the data.

A second challenge 514 may be that, even if the ADR process 510 is able to correctly identify the specific set of data sources required, the agent still needs to resolve how to map the data identified to the correct set of functions to retrieve such data. This can be particularly complex in scenarios with hundreds of data sources involving tens of thousands of possible functions that could be invoked by an agent (e.g., by the ADR process 510). In various implementations, such functions may comprise a Structured Query Language (SQL) statement, an API call, a custom data connector (e.g., an OpenAPI-based connector), a tool offered via a Model Context Protocol (MCP) server, a code snippet, an agent, or the like.

Today, generating answers to questions involving distributed data sources remains a manual process not suited to automation and/or LLM intervention due to these challenges and others. Instead, these operations are performed by experts or with the help of experts having knowledge in appropriate data sources.

Other approaches have included the use of retrieval augmented generation (RAG) techniques, where some enterprise data might be vectorized and available via RAG solutions. However, even companies that use RAG techniques typically won't “RAGify” all their data due to several concerns including: data duplication issues in brownfield environments; maintenance effort and cost; the challenges associated with adding RAG in scenarios subject to medium/high data dynamicity and varying relevance depending on data freshness; the technical limitations of state-of-the-art RAG techniques themselves (for instance: a) selecting the optimal search and re-ranking algorithm to prioritize the most relevant documents is not trivial; b) integrating identity, access management, and data from different identity providers is a challenge, etc.); etc.

### Automated Data to Function Mapping Using Agentic Prompt Processing Units

In contrast, the techniques described herein may facilitate automated data to function mapping using agentic prompt processing units (PPUs). The techniques introduced herein may provide verifiable means to correctly identify the enterprise data required before an agentic plan is executed along with automated mappings between a breakdown of the enterprise data required and a set of functions capable of retrieving such data. Further, techniques are also introduced enabling function description disambiguation.

Illustratively, the techniques described herein may be performed by hardware, software, and/or firmware, such as in accordance with function mapping process 248, which may include computer executable instructions executed by the processor(s) 220 (or independent processor of network interfaces 210) to perform functions relating to the techniques described herein.

Specifically, according to various implementations, a device obtains a natural language prompt for processing by a generative artificial intelligence model. The device identifies, prior to the generative artificial intelligence model processing the natural language prompt, a type of data that the generative artificial intelligence model would need to generate a response to the natural language prompt. The device identifies one or more data retrieval functions that are able to retrieve the type of data. The device provides an indication of the one or more data retrieval functions to the generative artificial intelligence model for use when processing the natural language prompt to generate the response.

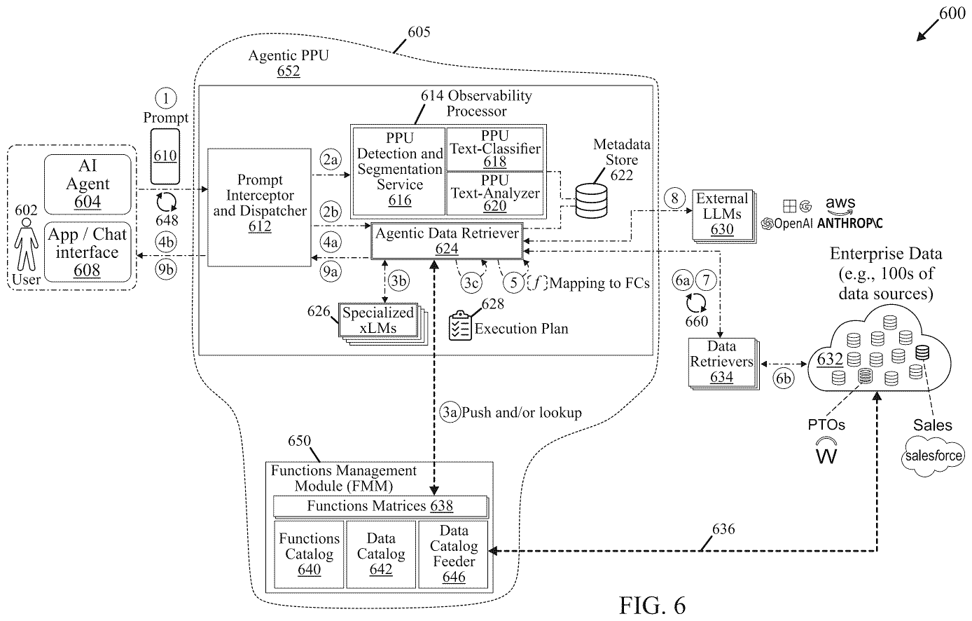

Operationally, FIG. 6 illustrates an example of an architecture 600 for retrieving data stored in enterprise data sources for incorporation in LLM prompting that leverages the system 605 for automated and manageable data to function mapping using agentic prompt processing units (PPUs), in accordance with one or more implementations described herein. Specifically, the system 605 may be configured to: a) identify and verify the one or more enterprise data records required to complete a prompt, if any, before an agentic plan is executed; b)provide automated means to map a breakdown of the enterprise data identified to complete a prompt and a set of functions capable of retrieving the correct data; c) enable the management and support of such mappings; d) disambiguate across various functions by targeted semantic separation across function descriptions; etc.

For instance, a user 602 that may use an application or chat interface 608 to generate a prompt 610 to be processed and completed by one of more large language models (LLMs) (e.g., LLMs 630). Prompt 610 may also be generated by a headless client, (e.g., AI agent 604).

A prompt 610 generated either by user 602 or AI agent 604 may reach and/or be intercepted by agentic PPU 652. More specifically, prompts 610 may be either intercepted or received by agentic PPU 652, which might be reachable as part of a SaaS deployment provisioned by a solution provider, or it might be deployed on premise as part of the company's infrastructure. For instance, some enterprises have developed multiple ways to intercept and transparently create copies of a prompt 610, including plugins for Cisco WebEx, Slack, Kong, python SDKs providing wrappers around widely used libraries, including OpenAI, Azure OpenAI and Langchain, as well as npm libraries for React.

In various implementations, the identification and verification of enterprise data required to complete a request carried in a prompt as well as the automation of data to function mapping techniques using agentic PPUs may be performed in architecture 600 by execution of one or more steps (e.g., steps 1-9).

For example, in step one a prompt 610 may be generated by a user 602 (e.g., via a chat interface 608) and/or by an AI agent 604. The prompt 610 may be intercepted by a prompt inceptor and dispatcher 612, which may be a client-facing element within the agentic PPU 652.

As step two, the prompt interceptor and dispatcher 612 may receive and simultaneously dispatch the prompt 610 both to an observability processor 614, and an agentic data retriever 624, in steps (2a), and (2b), respectively. Observability processor 614 may comprise a PPU detection and segmentation service 616, a PPU text-classifier 618, and a PPU Text-Analyzer 620 as well as a metadata store 622.

At a third step, the agentic data retriever 624 may parse the prompt 610 received in step (2b) and proceed as follows. At step 3a, the agentic data retriever 624 may push and/or issue a lookup request in one or more functions matrices (e.g., function matrices 638), which might be part of a functions management module (e.g., FMM 650). More specifically, FMM 650 may comprise function matrices 638, which may offer a structured model for indexing, searching, and identifying thousands of functions with specific focus on data access and retrieval.

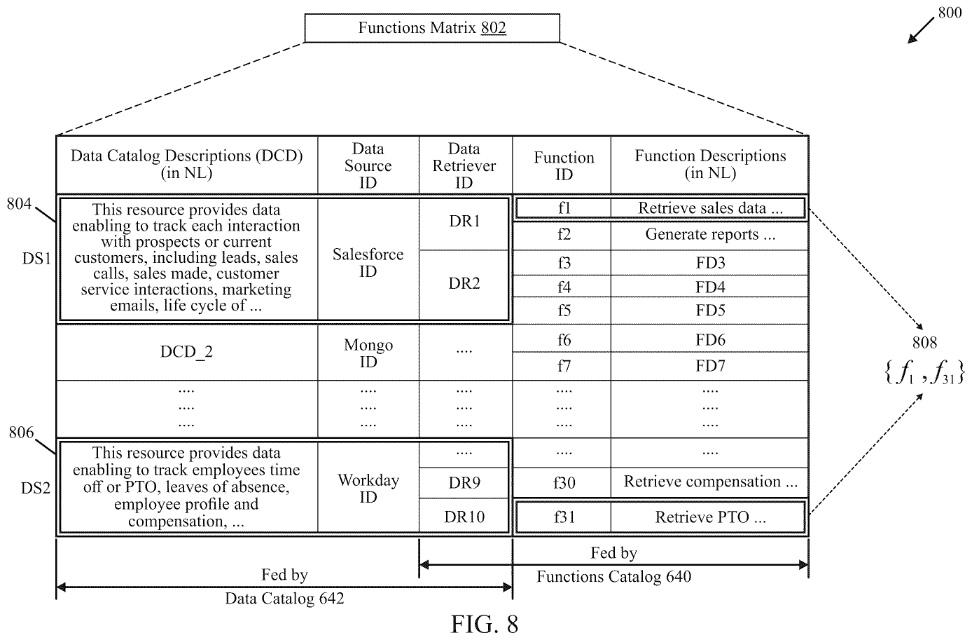

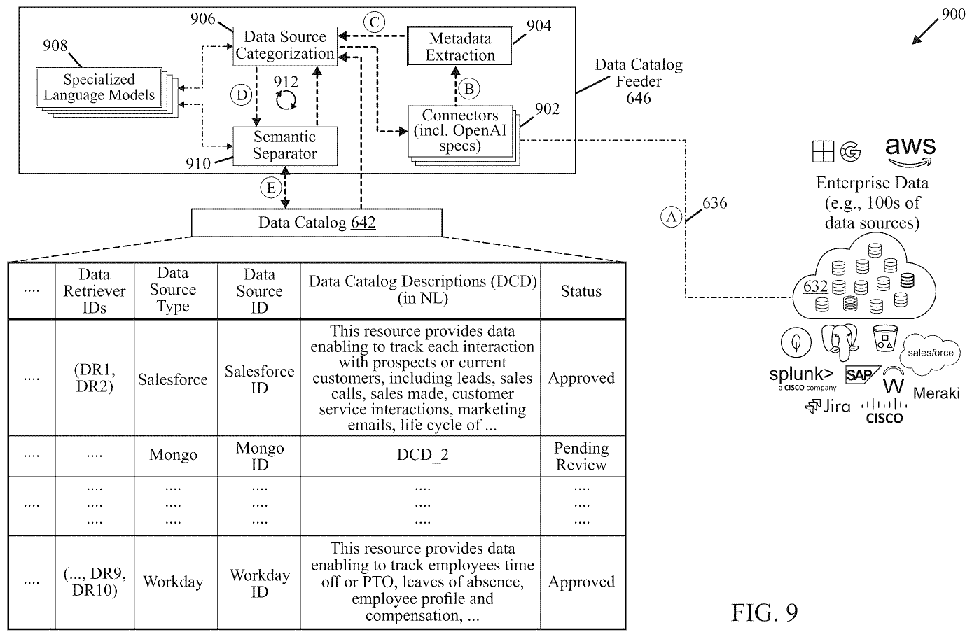

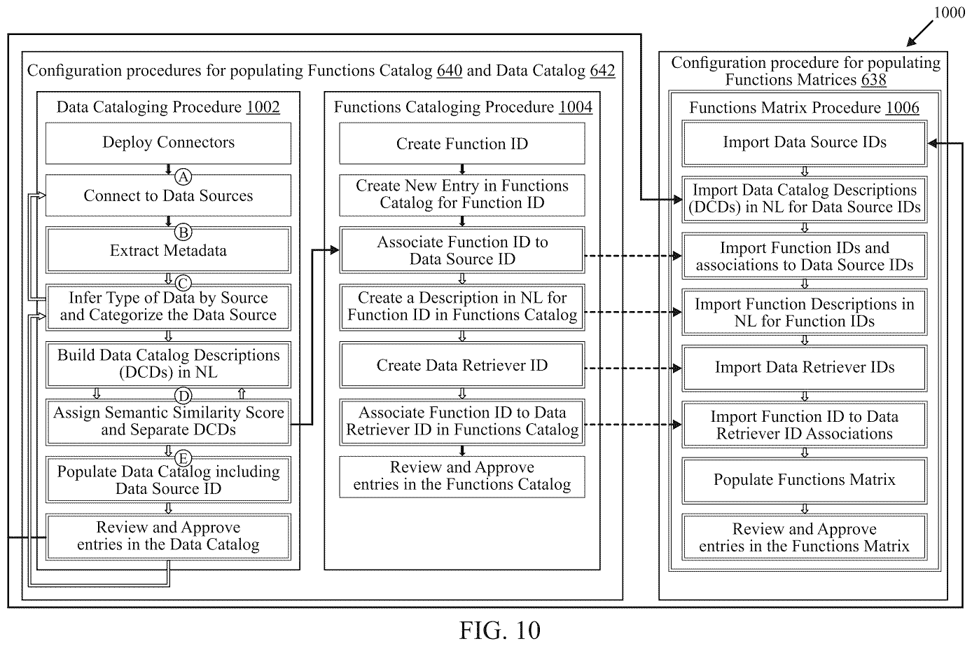

Function matrices 638 may be dynamically fed and populated using metadata from functions catalog 640, along with metadata from a data catalog 642, which in turn may be fed by data catalog feeder 646. The latter may use and support various types of connectors to enterprise data sources 632, through one or more interfaces 636 including, but not limited to, connectors submitted by Model Context Protocol (MCP) servers. Additional implementations describing the specific functionality and interactions across these various elements within FMM 650 are additionally detailed in subsequent figures (e.g., FIG. 8, FIG. 9, and FIG. 10).

A lookup may be performed in step (3a). This may result in the identification of a reduced set of plausible functions and their corresponding attributes as potential candidates to be called to retrieve the data requested in prompt 610. This reduced set of candidate functions may be used as an input to one or more specialized xLMs (e.g. specialized xLMs 626), where these may comprise and/or combine models of various sizes, including small, medium, or large language models.

More specifically, specialized xLMs 626 may be queried by agentic data retriever 624, in order to determine which specific functions should be called among the candidates identified. Furthermore, the identification and generation of a reduced set of plausible functions in step (3a) may also be supported by the one or more specialized xLMs (e.g. specialized xLMs 626), or by other models within FMM 650.

In step 3c, a plan 628 may be created for execution. For example, the agentic data retriever 624 may create an plan 628 based on the aforementioned operations. The plan 628 may include a breakdown of the enterprise data required to complete the request.

In a fourth step, an agentic data retriever 624 may expose the plan created, and request verification and validation before plan 628 is executed. To that end, agentic data retriever 624 may send the plan back via prompt interceptor and dispatcher 612 in step (4a), which in turn may forward the plan to the requestor in step (4b).

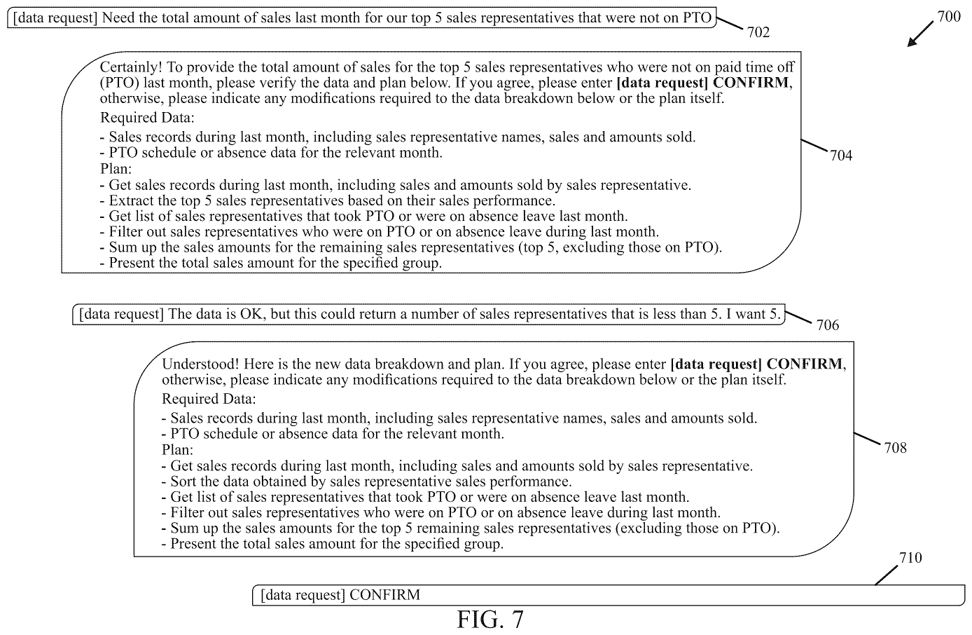

FIG. 7 illustrates an example of a plan confirmation procedure 700, where the contents of prompt 610 are illustrated as element 702, and the response received right after step (4b) as element 704. In plan confirmation procedure 700, a dialogue may be initiated to verify and confirm the plan with user 602 or AI agent 604 before its execution.

This may be enabled by loop 648 in FIG. 6, denoting that the steps (1)-(2)-(3)-(4) might be repeated until the plan is confirmed. For example, this may include the exchange of element 706, element 708, and/or element 710 with user 602 or AI agent 604. In an alternative implementation, the verification and confirmation process above described might be skipped and agentic data retriever 624 may proceed directly to step five.

Returning to discussion of FIG. 6, at step five the final plan created by agentic data retriever 624 may comprise a list of ordered steps to sequentially invoke and execute the final set of functions {f} identified, which may be automatically mapped to a specific set of data retrievers 634 by leveraging the mappings provided by function matrices 638.

At step six, agentic data retriever 624 may now start executing the plan. This may proceed by invoking a first data retriever within data retrievers 634 in step (6a) (e.g., implemented as a lambda function with a data connector and a runtime, an MCP server, or as yet another agent). A first data retriever may now obtain, in step (6b), the corresponding data from one or more enterprise data sources (e.g., enterprise data sources 632), as determined by the one or more functions identified in the set {f}. In order to deal with identity and delegated access control to the enterprise data sources 632, architecture 600 may leverage delegated data retrieval using agentic prompt processing units.

In step seven, the data obtained by a first data retriever may be sent back to the agentic data retriever 624, which may now observe the state of the execution of the plan and sequentially invoke a next data retriever from the data retrievers 634 as identified instep five. Agentic data retriever 624 may repeat steps six through seven as many times as needed using loop 660, in order to cover the various data retrievers identified and complete the execution of the plan. In some cases, the execution of the initial plan may fail (e.g., some steps may not be completed, some data might not be retrieved due to a connectivity failure, or an excessive delay in the response of a function call, etc.). In such cases, agentic data retriever 624 may be endowed with mechanisms to adapt and replan, leading to variants of steps five, six, and seven and the adaptation of the loop 660.

In step eight, once the data retrievals are completed, agentic data retriever 624 may request one or more LLMs (e.g., LLMs 630) to compile and prepare a final response to the original requestor (e.g., user 602 or AI agent 604). The final response may be forwarded to prompt interceptor and dispatcher 612 in step (9a), which in turn may send the prompt completion to the corresponding requestor in step (9b). Alternatively, step eight might also be performed by specialized xLMs 626, without the need to involve external LLMs 630. This case is particularly relevant for organizations that require data retrievals and processing by AI models using private data centers and/or on-premise infrastructures, so that they do not expose any data to external systems.

In various implementations, agentic data retriever 624 may detect that the prompt payload received in step (2b) does not require access to enterprise data sources 632, and therefore, the creation and execution of a plan to retrieve enterprise data is not needed. In such instances, agentic data retriever 624 may skip steps three to seven and proceed directly to step eight. For instance, this may be the case for prompt requests such as the following: “What does pip install do?” or “Translate the following text . . . ” In these examples, only the observability elements of observability processor 614 would be activated within the agentic PPU 652, as shown in step (2a). In such cases, the use of generic pre-trained AI modes, such as external LLMs 630, is even desired, thereby freeing specialized xLMs 626 from prompt completions that do not require the use of automated data to function mappings.

FIG. 8 illustrates an example of a component 800 of the system for automated and manageable data to function mapping using agentic prompt processing units (PPUs), in accordance with one or more implementations described herein. Component 800 comprises an example of a functions matrix 802 that may be part of function matrices (e.g., function matrices 638 in FIG. 6).

For instance, a prompt generated by user 602 may request: “Need the total amount of sales last month for our top five sales representatives that were not on PTO.” To complete the request, an agentic PPU 652 may require access to two different Data Sources (DSs), for example:
DS1, enabling agentic PPU to get sales records during last month, including sales and amounts sold by sales representative.
DS2, enabling Agentic PPU to get the list of sales representatives that took PTO or were on absence leave last month.

The lookup process in (e.g., step (3a) in FIG. 6) may use the functions matrix 802 to identify DS1 and DS2, and particularly, block 804 and block 806. Such blocks may contain data catalog descriptions (DCDs) in natural language as well as the identities of the data sources and the corresponding data retrievers (DRs).

The lookup process in (e.g., in step (3a) in FIG. 6) may leverage the descriptions in natural language in the various DCDs to identify the specific DSs (e.g., DS1 and DS2), and hence reduce the scope and the set of candidate functions that could be potentially invoked. As mentioned above, the identification and generation of such a reduced set of functions may be supported by the one or more specialized xLMs (e.g., specialized xLMs 626 in FIG. 6), or by other models within an FMM (e.g., FMM 650 in FIG. 6).

In order to refine the search and identify the concrete set of function IDs to be invoked within block 804 and block 806, the one or more specialized xLMs may now leverage natural language descriptions for each of the functions, as shown on the right-hand side of functions matrix 802. In the example, this may lead to the identification of functions {f1, f31} in 808.

A staged approach like the one described above, may help language models, such as specialized xLMs, to iterate, identify, and discern across a large number of functions (e.g., when the number of enterprise data sources might be in the order of hundreds or more, and thus, the number of potential functions might be in the order of thousands or tens of thousands).

FIG. 9 illustrates an example of a system 900 for feeding and populating a data catalog, in accordance with one or more implementations described herein. Specifically, data catalog feeder 646 may comprise a set of connectors (e.g., connectors 902), a metadata extraction module 904, a data source categorization process 906, a semantic separator process 910, and one or more specialized language models (e.g., specialized language models 908). Data catalog feeder 646 may use and support various types of connectors 902 to enterprise data sources 632, through one or more interfaces 636. The metadata extracted from enterprise data sources 632 may be used to: a) categorize the different data sources; b) automatically generate DCDs or digests in natural language using specialized language models 908; c) ensure that DCDs are semantically separated from each other; d) dynamically populate Data Catalog 642 with DCDs and metadata; etc.

In various implementations the functionality above described may be facilitated via a set of steps. For example, in steps (A)-(B) a set of connectors (e.g., connectors 902) may work in tandem with metadata extraction module 904 to connect and extract metadata, and only metadata, from enterprise data sources 632, including collections of structed, semi-structured, or unstructured data.

In step (C), the metadata extracted from the various sources may be used as an input to data source categorization process 906. The latter may leverage one of more of the specialized language models 908 to support such categorization or classification. Differently from existing methods in the prior art with focus on data security posture management (DSPM) or data compliance, where the metadata extracted by the different connectors is typically used to find sensitive data, such as personally identifiable information (PII), or payment card industry (PCI) information subject to data security standards (DSSs), the techniques introduced herein may aim at clustering the connectors 902, metadata extraction module 904, data source categorization process 906, and one or more of the specialized language models 908, to infer the nature of the data resources and categorize them, with the ultimate goal of automatically generating DCDs summarizing the contents for each data source.

A data source may have one or more DCDs associated to it, and as shown in FIG. 9, data source categorization process 906 may dynamically request connectors 902 for additional metadata, thereby allowing for various iterations across steps (A)-(B)-(C) to refine the data source categorization.

In steps (D)-(E), every time that a categorization and generation of a new DCD for a data source is completed, the semantic separator process 910 may analyze previous entries for DCDs in the data catalog 642 (if any), and it may use the one or more of the specialized language models 908 to ensure that the newly generated DCDs is semantically separated from other previous entries, before inserting the new DCD in the catalog in step (E). For instance, to make this possible, specialized language models 908 may represent fine-tuned models from pre-trained LLMs, where they might have been trained with a loss that penalizes either when a newly generated DCD is below a first semantic similarity signal from the ground-truth DCD, or above a second semantic similarity signal for any pair of DCDs in the catalog that include the newly generated DCD. That is, only new DCDs that lie between a first similarity signal when compared to the ground-truth DCD, and a second similarity signal when compared to all the pairs of DCDs in the catalog that have, e.g., the newly generated DCD as its first element, won't be penalized during the fine-tuning process.

As show in loop 912, the categorization and desired semantic separation between the various DCDs in the data catalog 642 may lead to various iterations in step (D).

In various implementations, data catalog 642 may be editable (e.g., by a domain expert with sufficient knowledge about the various data sources and their contents). In such case, further iterations may occur, by triggering steps (C)-(D) dynamically (e.g., right after editing and saving an existing DCD in the catalog). Such updates may be considered as new metadata in step (C), which might be finally reviewed and approved by a domain expert (e.g., as indicated in the status column on the right-hand side of the data catalog 642).

FIG. 10 illustrates an example of a configuration procedure 1000 for populating a functions catalog 640, a data catalog 642 as well as a function matrix within the function matrices 638. For example, a data cataloging procedure 1002 may proceed by deploying connectors, connecting to data sources, extracting metadata, inferring the type of the data by source and categorize the data source, building data catalog descriptions (DCDs) in NL, assigning semantic similarity score and separate DCDs, populating data catalog including data source ID, and/or reviewing and approving entries in the data catalog.

A functions cataloging procedure 1004 may proceed by creating a function ID, creating a new entry in a functions catalog for function ID, associating a function ID to a data source ID, creating a description in NL for function ID in the functions catalog, creating a data retriever ID, associating a function ID to data retriever ID in the functions catalog, and/or reviewing and approving entries in the functions catalog.

A functions matrix procedure 1006 may proceed by importing data source IDs, importing data catalog descriptions (DCDs) in NL for data source IDs, importing function IDs and associations to data source IDs, importing function descriptions in NL for function IDs, importing data retriever IDs, importing function ID to data retriever ID associations, populating a functions matrix, and/or reviewing and approving entries in the functions matrix.

It should be noted that while certain steps within the configuration procedure 1000, the data cataloging procedure 1002, the functions cataloging procedure 1004, the functions matrix procedure 1006 may be optional as described above, the steps shown are merely examples for illustration, and certain other steps may be included or excluded as desired. Further, while a particular order of the steps is shown, this ordering is merely illustrative, and any suitable arrangement of the steps may be utilized without departing from the scope of the implementations herein.

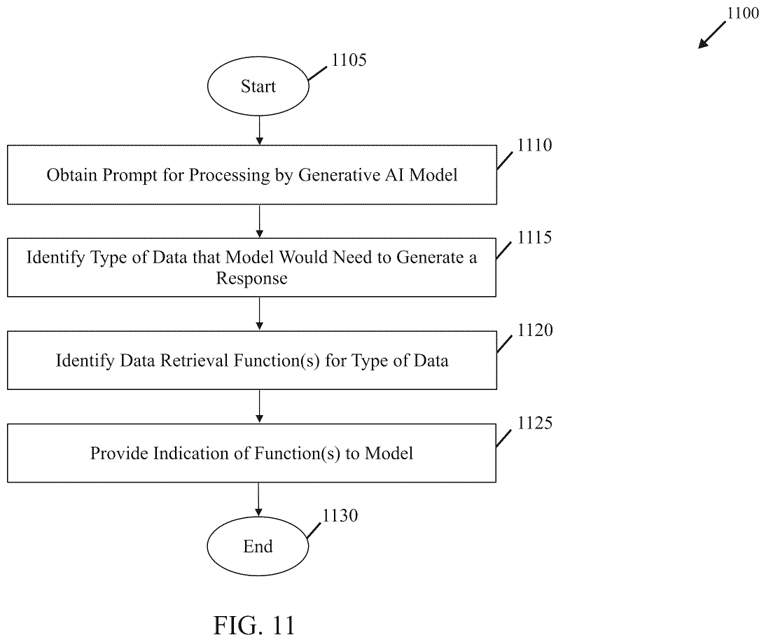

FIG. 11 illustrates an example simplified procedure (e.g., a method) for automated data to function mapping using agentic prompt processing units, according to various implementations. For example, a non-generic, specifically configured device (e.g., device 200), may perform procedure 1100 (e.g., a method) by executing stored instructions (e.g., function mapping process 248). The procedure 1100 may start at step 1105, and continues to step 1110, where, as described in greater detail above, the device (e.g., a controller, server, etc.) may obtain a natural language prompt for processing by a generative artificial intelligence model. In some implementations, the generative artificial intelligence model comprises a large language model. In various implementations, the device may obtain the prompt by intercepting the natural language prompt before it is input to the generative artificial intelligence model.

At step 1115, as detailed above, the device may identify, prior to the generative artificial intelligence model processing the natural language prompt, a type of data that the generative artificial intelligence model would need to generate a response to the natural language prompt. In various implementations, the device may do so by formulating an execution plan for the generative artificial intelligence model to generate the response.

At step 1120, the device may identify one or more data retrieval functions that are able to retrieve the type of data, as described in greater detail above. In some implementations, the device may do so by performing a lookup of the type of data in a catalog of data retrieval functions. In one implementation, an entry in the catalog associates the type of data with the one or more data retrieval functions, a data source, and an indication as to whether the one or more data retrieval functions have been approved by an administrator. In various implementations, the one or more data retrieval functions comprise at least one of: a Structured Query Language (SQL) statement, an application programming interface (API) call, a data connector a code snippet, a tool offered via an MCP server, or an agent configured to retrieve the type of data. In some implementations, this step may also disambiguating a set of data retrieval functions that comprise the one or more data retrieval functions by applying targeted semantic separation to their associated function descriptions.

At step 1125, as detailed above, the device may provide an indication of the one or more data retrieval functions to the generative artificial intelligence model for use when processing the natural language prompt to generate the response. In various implementations, the device may also obtain, from a user interface that originated the natural language prompt, confirmation of the type of data that the generative artificial intelligence model would need to generate a response to the natural language prompt, whereby the device provides the indication of the one or more data retrieval functions based in part on the confirmation. In various implementations, the generative artificial intelligence model uses the one or more data retrieval functions to access the type of data from one or more data sources. In some cases, the device may also provide the response from the generative artificial intelligence model to a user interface that originated the natural language prompt.

Procedure 1100 may then end at step 1130.

It should be noted that while certain steps within procedure 1100 may be optional as described above, the steps shown in FIG. 11 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduce a data to function mapping technique using agentic prompt processing units (PPUs). The techniques introduced herein provide verifiable means to correctly identify the enterprise data required before an agentic plan is executed along with automated mappings between a breakdown of the enterprise data required and a set of functions capable of retrieving such data. Techniques are also introduced enabling function description disambiguation.

While there have been shown and described illustrative implementations that provide for automated data to function mapping using agentic prompt processing units (PPUs), it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
obtaining, by a device, a natural language prompt for processing by a generative artificial intelligence model;
identifying, by the device and prior to the generative artificial intelligence model processing the natural language prompt, a type of data that the generative artificial intelligence model would need to generate a response to the natural language prompt;
identifying, by the device, one or more data retrieval functions that are able to retrieve the type of data; and
providing, by the device, an indication of the one or more data retrieval functions to the generative artificial intelligence model for use when processing the natural language prompt to generate the response.

2. The method as in claim 1, wherein identifying the one or more data retrieval functions that are able to retrieve the type of data comprises:
disambiguating a set of data retrieval functions that comprise the one or more data retrieval functions by applying targeted semantic separation to their associated function descriptions.

3. The method as in claim 1, wherein identify the type of data that the generative artificial intelligence model would need to access comprises:
formulating, by the device, an execution plan for the generative artificial intelligence model to generate the response.

4. The method as in claim 1, further comprising:
obtaining, by the device and from a user interface that originated the natural language prompt, confirmation of the type of data that the generative artificial intelligence model would need to generate a response to the natural language prompt, wherein the device provides the indication of the one or more data retrieval functions based in part on the confirmation.

5. The method as in claim 1, wherein identifying the one or more data retrieval functions that are able to retrieve the type of data comprises:
performing a lookup of the type of data in a catalog of data retrieval functions.

6. The method as in claim 5, wherein an entry in the catalog associates the type of data with the one or more data retrieval functions, a data source, and an indication as to whether the one or more data retrieval functions have been approved by an administrator.

7. The method as in claim 1, wherein obtaining the natural language prompt comprises:
intercepting the natural language prompt before it is input to the generative artificial intelligence model.

8. The method as in claim 1, wherein the generative artificial intelligence model uses the one or more data retrieval functions to access the type of data from one or more data sources.

9. The method as in claim 1, further comprising:
providing the response from the generative artificial intelligence model to a user interface that originated the natural language prompt.

10. The method as in claim 1, wherein the one or more data retrieval functions comprise at least one of: a Structured Query Language (SQL) statement, an application programming interface (API) call, a data connector a code snippet, a Model Context Protocol (MCP) server, or an agent configured to retrieve the type of data.

11. An apparatus, comprising:
one or more network interfaces;
a processor coupled to the one or more network interfaces and configured to execute one or more processes; and
a memory configured to store a process that is executable by the processor, the process when executed configured to:
obtain a natural language prompt for processing by a generative artificial intelligence model;
identify, prior to the generative artificial intelligence model processing the natural language prompt, a type of data that the generative artificial intelligence model would need to generate a response to the natural language prompt;
identify one or more data retrieval functions that are able to retrieve the type of data; and
provide an indication of the one or more data retrieval functions to the generative artificial intelligence model for use when processing the natural language prompt to generate the response.

12. The apparatus as in claim 11, wherein the apparatus identifies the one or more data retrieval functions that are able to retrieve the type of data by:
disambiguating a set of data retrieval functions that comprise the one or more data retrieval functions by applying targeted semantic separation to their associated function descriptions.

13. The apparatus as in claim 11, wherein the apparatus identifies the type of data that the generative artificial intelligence model would need to access by:
formulating an execution plan for the generative artificial intelligence model to generate the response.

14. The apparatus as in claim 11, wherein the process when executed is further configured to:
obtain, from a user interface that originated the natural language prompt, confirmation of the type of data that the generative artificial intelligence model would need to generate a response to the natural language prompt, wherein the apparatus provides the indication of the one or more data retrieval functions based in part on the confirmation.

15. The apparatus as in claim 11, wherein the apparatus identifies the one or more data retrieval functions that are able to retrieve the type of data by:
performing a lookup of the type of data in a catalog of data retrieval functions.

16. The apparatus as in claim 15, wherein an entry in the catalog associates the type of data with the one or more data retrieval functions, a data source, and an indication as to whether the one or more data retrieval functions have been approved by an administrator.

17. The apparatus as in claim 11, wherein the apparatus obtains the natural language prompt by:
intercepting the natural language prompt before it is input to the generative artificial intelligence model.

18. The apparatus as in claim 11, wherein the generative artificial intelligence model uses the one or more data retrieval functions to access the type of data from one or more data sources.

19. The apparatus as in claim 11, wherein the process when executed is further configured to:
provide the response from the generative artificial intelligence model to a user interface that originated the natural language prompt.

20. A tangible, non-transitory, computer-readable medium storing program instructions that cause a device to execute a process comprising:
obtaining, by the device, a natural language prompt for processing by a generative artificial intelligence model;
identifying, by the device and prior to the generative artificial intelligence model processing the natural language prompt, a type of data that the generative artificial intelligence model would need to generate a response to the natural language prompt;
identifying, by the device, one or more data retrieval functions that are able to retrieve the type of data; and
providing, by the device, an indication of the one or more data retrieval functions to the generative artificial intelligence model for use when processing the natural language prompt to generate the response.
